(19) United States
(12) Patent Application Publication
(10) Pub. No.: US 2006/0012962 A1
(43) Pub. Date: Jan. 19, 2006

(54) Display device

(75) Inventor: Yuuki Obata, Tokyo (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation

(21) Appl. No.: 11/142,670

(22) Filed: Jun. 2, 2005

(30) Foreign Application Priority Data
Jun. 4, 2004 (JP) 2004-166909

(51) Int. Cl. G09G 3/28

(52) U.S. Cl. 361/704; 345/60; 313/582

(57) ABSTRACT

A display device, particularly a plasma display device, low in cost and small in mass, having a display panel capable of being prevented from deforming even upon application of an external force to the front panel. A plasma display device includes an exterior housing by the provision of a frame-formed front panel and a back cover, to provide a PDP within the same. A module plate and a heat sink are provided in a back of the PDP and fixed to the PDP. The heat sink is in a squared-U form that one plate is bent perpendicular twice, having a portion fixed to the PDP and another portion abutting against a backside of the front panel. A gap is provided between a functional film put on a front-side substrate of the PDP and the front panel.

### BACKGROUND OF THE INVENTION

1. Field of the Invention

The present invention relates to display devices and more particularly to a plasma display device.

2. Description of Related Art

Conventionally, the plasma display device has been developed as a slim display. The plasma display device is a display having a plasma display panel (hereinafter, referred to as PDP) as a display panel thereof. The PDP is formed by two glass substrates arranged parallel with each other and a discharge gas filled between the substrates. In the PDP, a great deal of unwanted radiation of electromagnetic wave occurs in the operation thereof. For this reason, a front-sided filter is provided of tempered glass in front of the PDP, i.e. close to the viewer, in order to shield the unwanted portion of radiation by means of the front filter.

However, there is a recently developed plasma display device omitted of the tempered-glass front filter in order to reduce the cost and weight for the plasma display device. See Japanese Patent Kokai No. 2001-343898 (Patent Document 1), for example. FIG. 1 is a sectional view showing a structure of the plasma display device in the prior art. The conventional plasma display device is provided with a front panel 5 in a frame form, as shown in FIG. 1. The front panel 5 is usually formed of a resin due to the reason of the capability of securing the freedom in shape, suppressing the cost and reducing the mass. Meanwhile, the front panel 5 is joined with a back cover 9 through a spacer 13 by means of a bolt 14.

A PDP 1 is provided within an exterior housing made up by the front panel 5 and the back cover 9. In the PDP 1, two non-tempered glass substrates are arranged parallel to seal a discharge gas between the substrates. Meanwhile, a transparent functional film 2 is put directly on a front-sided surface of the PDP 1 in order to shield against unwanted portions of radiation. The front panel 5 covers a peripheral region of the front surface, i.e. the surface put with the functional film 2, of the PDP 1. The display area excepting the peripheral region lies within an aperture of the front panel 5. This allows a viewer to view the PDP 1 through the aperture of the front panel 5. Incidentally, in the plasma display device, the front panel 5 has an end edge, closer to the aperture, in contact with the functional film 2 of the PDP 1 without the provision of a tempered-glass front filter.

In the back of the PDP 1, a module plate 3 is arranged and fixed to the PDP 1. The module plate 3 is fixed thereon with a PDP drive board 7. Furthermore, the PDP drive board 7 is connected to a terminal (not shown) formed on a rear-side substrate of the PDP 1 through a flexible cable 4. Furthermore, the module plate 3 is fixed with a heat sink 8. Meanwhile, a film ground metal 11 is connected at a peripheral region of the functional film 2, i.e. between a region arranged rear of the front panel 5 and concealed within the exterior housing, to provide a grounding to the functional film 2.

In the conventional plasma display device, the functional film 2 is directly put on the front surface of the PDP 1. This makes it possible to shield against the unwanted portion of radiation from the PDP 1 without providing a front filter of tempered glass, thus achieving cost and weight reduction for the plasma display device.

However, the prior art involves the following problem. In the conventional plasma display device shown in FIG. 9, when an external force is applied, the resin-make front panel 5 deflects to possibly push the PDP 1 inwards. Meanwhile, there is a fear of causing a deformation in the PDP 1 because the functional film 2 has a less capability of resisting to an external force.

Meanwhile, this problem is not limited to the plasma display device but is present generally in the display device having a display panel and a front panel. Namely, where the tempered-glass front filter is omitted in order to achieve the reduction of cost and weight, there is a possibility that the front panel is deformed when an external force is applied to the front panel.

### SUMMARY OF THE INVENTION

The present invention has been made in view of the foregoing problem, and it is an object thereof to provide a display device, particularly a plasma display device, low in cost and small in mass, which is free from operational trouble even upon application of an external force to the front panel.

A display device according to the invention comprises: a display panel; a front panel covering at least one part of a region other than a display region of the display panel; and a drive component connected to the display panel and for driving the display panel; the drive component being fixed on the display panel, wherein at least one of constituent members configuring the drive component is in abutment against the front panel.

In the invention, the drive component is fixed on the display panel and abutted against the front panel. Even when an external force is applied to the front panel, the drive component acts as a support thus suppressing the front panel from deforming. Meanwhile, even in case a strong force is applied to deform the front panel, the drive component and the display panel entirely deflect rearward due to the deformation, making it possible to prevent the display panel from deforming. Due to this, even where the display device is attempted to reduce its cost and weight by omitting the front-side filter formed of a tempered glass or the like, the display panel can be prevented against deformation.

A display device in another aspect of the invention comprises: a display panel; a front panel covering a peripheral region in a front surface of the display panel and exposing a display region thereof; and a drive component connected to the display panel and for driving the display panel; the drive component being fixed on the display panel, wherein at least one of constituent members configuring the drive component is in abutment against the front panel.

In the invention, the drive component is fixed on the display panel and abutted against the backside of the front panel. Even when an external force is applied to the front panel, the drive component acts as a support thus suppressing the front panel from deforming. Meanwhile, even in case a stronger force is applied and the front panel is deformed rearward, the drive component is deflected rearward by the deformation so that the display panel deflects and moves rearward due to the deflection. This can relax or eliminate the application force of the front panel to the display panel, and prevent the display panel from deforming due to the front panel pushing the display panel. Due to this, even in case the cost and weight is reduced in the display device by omitting the front-side filter formed of tempered glass or the like, the display panel can be prevented against deformation.

Meanwhile, the drive component may have a drive circuit device for driving the display panel and a heat sink for releasing a heat generated from the drive circuit device, the heat sink being fixed on the display panel and abutted against a backside of the front panel. In this case, the heat sink may have a first portion arranged rear of the display panel and fixed on the display panel and a second portion extending frontward from an end of the first portion and passing laterally of the display panel into an abutment against the front panel, or the front panel may have a rib provided standing rearward, the rib being abutted against the heat sink. Due to this, by supporting the front panel through utilization of the heat sink, the front panel can be suppressed from being deformed. Furthermore, when a greater force is applied to deform the front panel, the display panel can be deflected rearward in proportion to the external force. Thus, cost increase can be suppressed without the need to provide a new component.

Otherwise, the drive component may have a drive circuit device for driving the display panel and a module plate supporting the drive circuit device, the module plate being fixed on the display panel and abutted against a backside of the front panel. In this case, the module plate may have a main body portion arranged rear of the display panel and fixed on the display panel to thereby support the drive circuit device, and an extended portion extending frontward from an end of the main body portion and passing laterally of the display panel into abutment against the front panel. Otherwise, the front panel may have a rib provided standing rearward, the rib being abutted against the module plate. Due to this, by supporting the front panel through utilization of the module plate, the front panel can be suppressed from deforming. Furthermore, when a greater force is applied to deform the front panel, the display panel can be deflected rearward depending upon the external force. Thus, cost increase can be suppressed without the necessity of providing a new component.

Otherwise, the drive component may have a drive circuit device for driving the display panel, a module plate fixed on the display panel and supporting the drive circuit device, and a reinforcing member joined to the module plate and abutted against a backside of the front panel.

Furthermore, the display panel may have a film put on a front-side substrate of the display panel and shielding an electromagnetic wave radiated from the display panel. In this case, a connection member may be included to electrically connect the film with the drive component.

Furthermore, the display panel may be a plasma display panel.

A plasma display device according to a first aspect of the invention comprises: a plasma display panel; a front panel covering a peripheral region in a front surface of the plasma display panel and exposing a display region thereof; a drive circuit device for driving the plasma display panel; and a heat sink fixed on the plasma display panel and abutted against a backside of the front panel, to thereby release a heat generated from the drive circuit device.

A plasma display device according to a second aspect of the invention comprises: a plasma display panel; a front panel covering a peripheral region in a front surface of the plasma display panel and exposing a display region thereof; a drive circuit device for driving the plasma display panel; and a module plate fixed on the plasma display panel and abutted against a backside of the front panel, thus supporting the drive circuit device.

A plasma display device according to a third aspect of the invention comprises: a plasma display panel; a front panel covering a peripheral region in a front surface of the plasma display panel and exposing a display region thereof; a drive circuit device for driving the plasma display panel; a module plate fixed on the plasma display panel and supporting the drive circuit device; and a heat sink fixed on the plasma display panel and abutted against a backside of the front panel, to thereby release a heat generated from the drive circuit device; the module plate having an end abutting against an abutment portion of the heat sink against the front panel.

A plasma display device according to a fourth aspect of the invention comprises: a plasma display panel; a front panel covering a peripheral region in a front surface of the plasma display panel and exposing a display region thereof; and a reinforcement member fixed on the plasma display panel and abutting against a backside of the front panel.

A plasma display device according to a fifth aspect of the invention comprises: a plasma display panel; a front panel covering a peripheral region in a front surface of the plasma display panel and exposing a display region thereof; a drive circuit device for driving the plasma display panel; and a heat sink fixed on the plasma display panel and for releasing a heat generated from the drive circuit device; the front panel being formed with a rib provided standing rearward, the rib having a tip abutting against the heat sink.

According to the invention, the drive component for driving the display panel is fixed on the display panel and abutted against the backside of the front panel. In case an external force is applied to the front panel, the drive component acts as a support thus making it possible to suppress the front panel from deforming. Meanwhile, in the event a stronger force is applied to deform the front panel rearward, the drive component and the display panel are deflected entirely rearward. The force the front panel pushes the display panel inward can be eliminated or relaxed, thus preventing the display panel from being deformed due to strong pushing the display panel by the front panel. As a result, because of no provision of a front filter formed of a tempered glass or the like at a front of the display panel, a display device can be obtained at low cost and smaller mass whose display panel can be prevented from deforming even in case an external force is applied to the front panel.

### BRIEF DESCRIPTION OF THE DRAWINGS

FIG. 1 is a sectional view showing a plasma display device in the prior art;

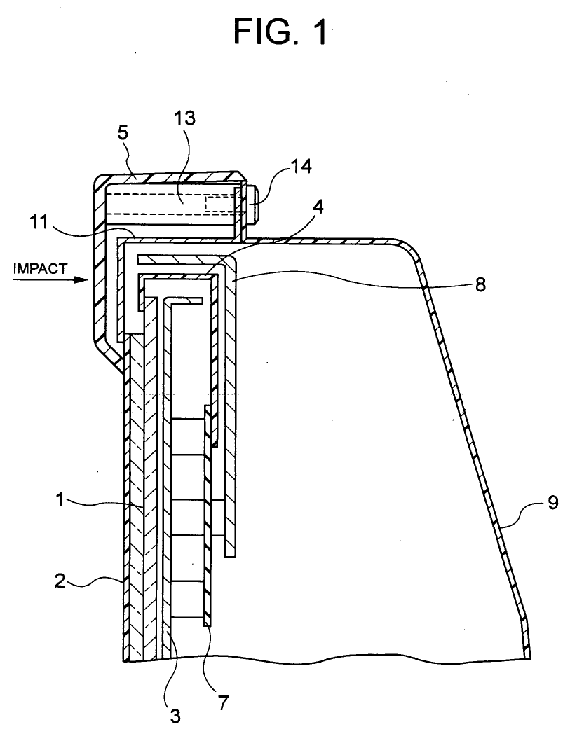

FIG. 2 is a sectional view showing a plasma display device according to a first embodiment of the present invention;

FIG. 3 is a sectional view showing a plasma display device according to a modification to the first embodiment of the invention;

FIG. 4 is a sectional view showing a plasma display device according to a second embodiment of the present invention;

FIG. 5 is a sectional view showing a plasma display device according to a modification to the second embodiment of the invention;

FIG. 6 is a sectional view showing a plasma display device according to a third embodiment of the present invention;

FIG. 7 is a sectional view showing a plasma display device according to a modification to the third embodiment of the invention;

FIG. 8 is a sectional view showing a plasma display device according to a fourth embodiment of the present invention; and

FIG. 9 is a sectional view showing a plasma display device according to a fifth embodiment of the present invention.

### DETAILED DESCRIPTION OF THE INVENTION

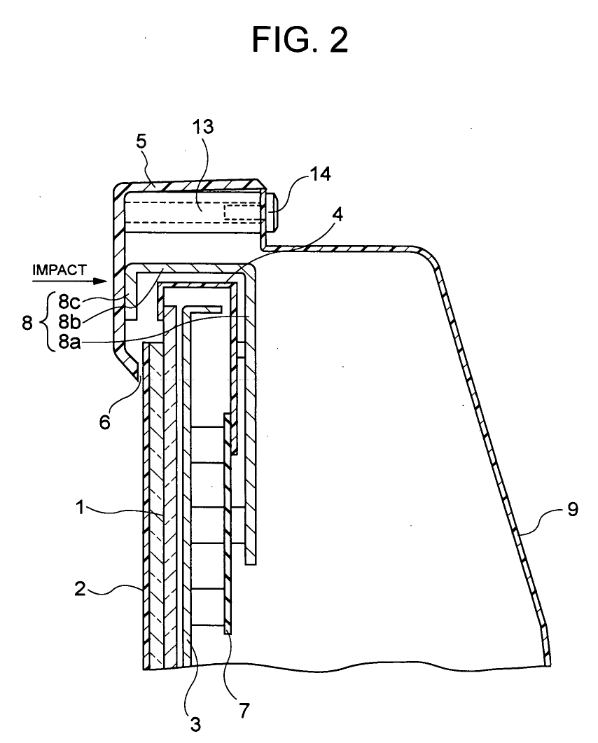

With reference to the attached drawings, explanation will be now made on embodiments of the present invention. First explained is a first embodiment of the invention. FIG. 2 is a sectional view showing a structure of a plasma display device according to the present embodiment. The plasma display device in this embodiment is provided with a front panel 5 formed of resin in a frame form. Meanwhile, the front panel 5 is joined with a spacer 13 while the spacer 13 is joined with a back cover 9 by means of a bolt 14. Namely, the spacer 13 is circular in form forming a screw hole along the axis thereof. A bolt 14 is screwed in the screw hole. Note that the spacer 13 may be formed integral with the front panel 5 at the inward of the front panel 5. The front panel 5 and a back cover 9 form an exterior housing for the plasma display device.

A PDP 1 is provided at an interior of the exterior housing. A support (not shown) which is to support the PDP 1 is provided below the PDP 1. In the PDP 1, two non-tempered glass substrates are arranged parallel with each other to seal a discharge gas between the substrates. Meanwhile, the PDP 1 is provided thereon with a transparent functional film 2 for shield against the electromagnetic wave, i.e. unwanted radiation, of from the PDP 1. The functional film 2 is bonded directly on the front-side substrate of the PDP 1. The PDP 1 has a front surface, i.e. a surface bonded with the functional film 2, covered by and concealed by the front panel 5 in a peripheral region thereof. Meanwhile, the display region of the PDP 1 is positioned within an aperture through the front panel 5 and exposed to the outside. This allows the viewer to view the display region of the PDP 1 through the aperture of the front panel 5. Note that, in the description, the direction toward the viewer as viewed from the display device is referred to as the front, the direction opposite thereto is as the rear, and the direction orthogonal to the front and rear is collectively as the lateral.

The front panel 5 is not in contact with the functional film 2 of the PDP 1. A gap 6 of nearly 0.1 to 1.0 mm, for example, is provided between an end edge of the front panel 5 closer to the aperture and the functional film 2. Furthermore, a module plate 3 is arranged on the back side of the PDP 1 and joined to the backside of the PDP 1, thus being fixed on the PDP 1. Furthermore, the module plate 3 is fixed with a PDP drive board 7. A flexible cable 4 is connected between the PDP drive board 7 and the back substrate of the PDP 1. Namely, the flexible cable 4 has one end connected to a terminal (not shown) of the PDP drive board 7. The flexible cable 4 is laid from a connection with the PDP drive board 7 in a manner extending laterally of the back-side substrate of the PDP 1. The other end of the flexible cable 4 is connected to a terminal (not shown) formed on the back-side substrate of the PDP 1. A driver IC (integrated circuit, not shown) is formed on the flexible cable 4. Incidentally, the PDP drive board 7 and the driver IC constitute a drive circuit for PDP 1.

Meanwhile, the module plate 3 is firmly fixed with a heat sink 8. The heat sink 8 is formed of a metal or an alloy to release the heat generated from the driver IC into the air. The heat sink 8 is in a squared-U form that one plate is bent perpendicular twice. Namely, the heat sink 8 has a portion 8a, a portion 8b connected to an end of the portion 8a and extending perpendicular to a surface of the portion 8a, and a portion 8c connected to an end opposite to the end of portion 8b connecting the portion 8a and extending perpendicular to a surface of the portion 8b into an arrangement in a position opposite to the portion 8a. The portion 8a is provided rear of the PDP drive board 7 and parallel with the PDP 1, thus being joined to the module plate 3 and driver IC. This fixes the portion 8a to the PDP 1. Meanwhile, the portion 8b is arranged in a manner extending frontward from the portion 8a, thus extending laterally of the module plate 3 and PDP 1. The portion 8c is arranged parallel with the portion 8a and abutted against a backside of the front panel 5. This constitutes a support component fixed to the PDP 1 through the module plate 3 and heat sink 8 and abutted against the backside of the front panel 5, to hold the PDP 1 in a position spaced from the front panel 5 through the gap 6. Meanwhile, a drive component for driving the PDP 1 is constituted by the module plate 3, the PDP drive board 7, the flexible cable 4, the driver IC and the heat sink 8.

Meanwhile, a film ground metal (not shown) is connected in a peripheral region of the functional film 2, i.e. between a region arranged rear of the front panel 5 and concealed within the exterior housing and the back cover 9, thus providing a grounding from the functional film 2.

Referring to FIG. 2, explanation is now made on the operation of the plasma display device in this embodiment constructed as above. In the event that an external force such as an impact is applied to the front panel 5 during packaging/shipment or setting up of the plasma display device, the front panel 5 is deformed inward, i.e. rearward, by the external force undergone. However, the heat sink 8 abuts against the inner surface of the front panel 5 (backside), to support the front panel 5 upon the application of an external force to the front panel 5. For this reason, the front panel 5 is not deformed to maintain the gap 6, thus preventing the deformation in the glass substrate of the PDP 1.

Meanwhile, should a strong force be applied, the front panel 5 deforms rearward. At this time, the front panel 5 is abutted against by the heat sink 8 wherein the heat sink 8, the module plate 3 and the PDP 1 are connected one with another. By the deformation in the front panel 5, deflection is caused rearward entirely in the structure made up by the drive component including the heat sink 8 and the module plate 3 and the PDP 1. Because this moves the PDP 1 rearward, the gap 6 is maintained. This eliminates the possibility to place the front panel 5 into contact with the functional film 2 and push the PDP 1 inward. Meanwhile, even when the gap 6 is vanished by the deformation in the front panel 5 thereby placing the front panel 5 into contact with the PDP 1, the front panel 5 can reduce the force pushing the PDP 1 because of a rearward movement of the PDP 1. Namely, in the conventional plasma display device, the PDP is ready to be broken because of a force concentration at a point the front panel is contacted with the PDP. However, in the present embodiment, the external force applied to the front panel 5 is weakened by the deformation in the heat sink 8 and module plate 3 and then distributed to the PDP 1 in its entirety. Thus, there is no possibility of a concentration of force at one point of the PDP 1, less causing a deformation in the PDP 1. Due to this, should such a strong external force be applied as to deform the front panel 5 reinforced by the heat sink 8, no damage occurs in the PDP 1 itself. Accordingly, the plasma display device can be repaired comparatively at a low cost by exchanging the front panel 5 or so.

In the present embodiment, the functional film 2 put on the front-side substrate of the PDP 1 thus making it possible to shield the unwanted radiation caused due to the operation of the PDP 1. Because of no provision of a front-surface filter formed of tempered glass, the plasma display device can be reduced in cost and weight. Meanwhile, in this embodiment, even when an external force such as an impact is applied to the front panel 5, the above structure can prevent the deformation of the PDP 1 without the direct application of a force to the PDP 1 from the front panel 5 thus preventing the deformation in the PDP 1. This embodiment does not require to newly add a member to the conventional plasma display device. This can realize such a structure as can prevent against PDP 1 deformation without substantial increase of cost.

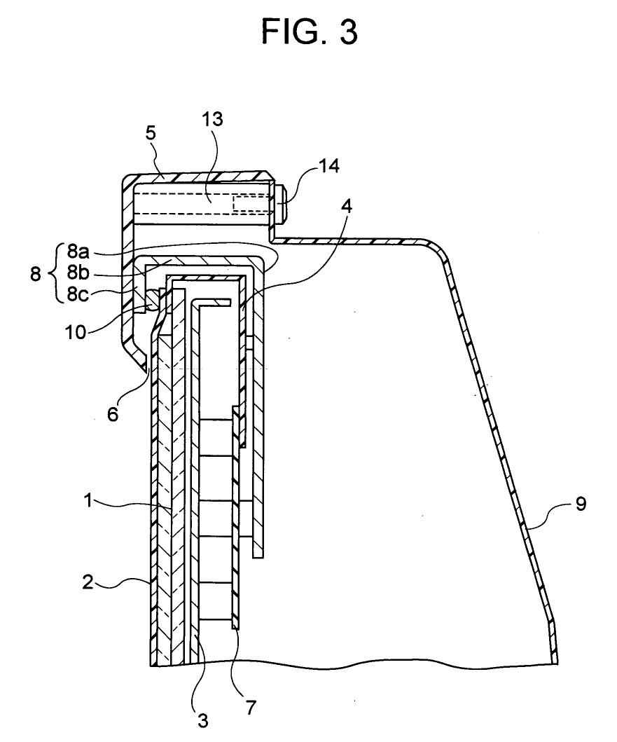

Now explained is a modification to the first embodiment. FIG. 3 is a sectional view showing a plasma display device according to the present modification. In this modification, the functional film 2 is extended protruding out of the end edge of the PDP 1 front-side substrate and contacted with a connection of the flexible cable 4 to the PDP 1 back substrate. The functional film 2 has an area at least contacted with the flexible cable 4 where a metal mesh or metal foil is formed on an opposite surface to the surface contacted with the flexible cable 4. A gasket 10 is arranged between the area of functional film 2 contacted with the flexible cable 4 and the portion 8C of the heat sink 8. The gasket 10 is bonded to the portion 8C of the heat sink 8. The gasket 10 has an electric conductivity and elasticity by which it is adhered to the functional film 2 and heat sink 8 and electrically connecting the metal mesh or foil of the functional film 2 with the heat sink 8. The heat sink 8 is connected to the module plate 3. The other of structure than the above in this modification is similar to the first embodiment.

In this modification, because the functional film 2 is connected to the module plate 3 through the gasket 10 and heat sink 8, the functional film 2 can be grounded without providing a film ground metal, thus enabling to reduce the unwanted radiation of an electromagnetic wave of from the PDP 1. Due to this, this modification reduces the cost of the plasma display device because of no necessity of a film ground metal. The other operation and effect of the modification than the above is similar to the first embodiment.

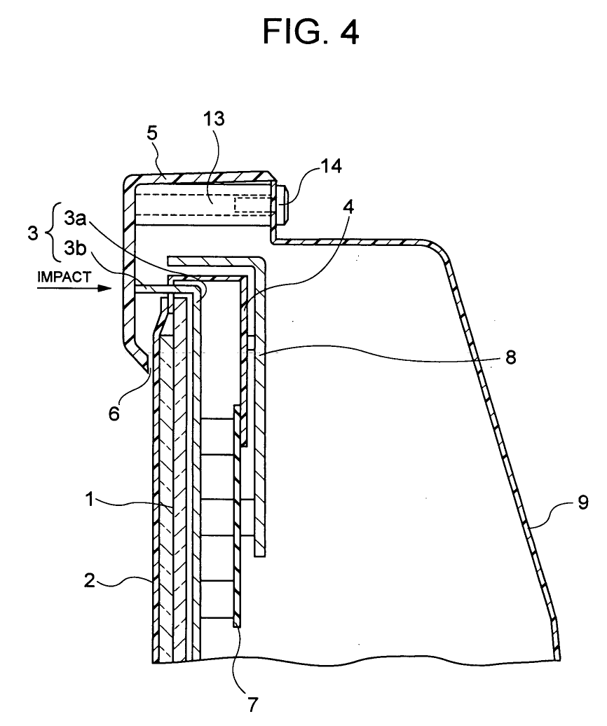

Now explained is a second embodiment of the invention. FIG. 4 is a sectional view showing a plasma display device according to this embodiment. In the plasma display device in this embodiment, the module plate 3 has an end bent extending frontward and abutting against a backside (inner surface) of the front panel 5, as shown in FIG. 4. Namely, the module plate 3 has a main body portion 3a arranged parallel with the PDP 1 and an extended portion 3b extending frontward from the main body portion 3a and abutting against the backside of the front panel 5. The main body portion 3a is joined to a backside of the PDP 1 and fixed to the PDP 1, thus fixingly supporting the PDP drive board 7. The extended portion 3b of the module plate 3 is made in such a form not to interfere with the flexible cable 4, e.g. comb form. Namely, the extended portion 3b has a plurality of strap-formed teeth mutually arranged parallel so that the flexible cable 4 can be inserted between the teeth. The heat sink 8 is not abutted against the front panel 5 but joined to a driver IC (not shown) mounted on the module plate 3 and flexible cable 4. This structures a support member which is fixed to the PDP 1 by the module plate 3 and abutting against the backside of the front panel 5, to thereby support the PDP 1 in a position spaced through a gap 6 from the front panel 5. The other of structure in this modification than the above is similar to the first embodiment.

Now explained is the operation of this embodiment structured as above. In the plasma display device in this embodiment, the extended portion 3b of the module plate 3 abuts against the inner surface of the front panel 5. In the case an external force such as an impact is applied to the front panel 5, the module plate 3 acts as a support to the front panel 5 thus suppressing the front panel 5 from deforming. Meanwhile, should the front panel 5 be deformed due to the application of a strong external force, the front panel 5 deforms to thereby deflect the entire of the module plate 3 and PDP 1 rearward, thus maintaining the gap 6 between the front panel 5 and the PDP 1 functional film 2. As a result, the PDP 1 is free from the direct application of a force and hence from a deformation. Meanwhile, even when the front panel 5 is deformed to vanish the gap 6 and place the front panel 5 into contact with the PDP 1, the force of the front panel 5 pushing the PDP 1 is weakened because of rearward movement of the PDP 1, thus preventing the PDP 1 from deforming.

This embodiment can shield the electromagnetic wave radiated from the PDP 1 because the functional film 2 is put on the front-side substrate of the PDP 1. By omitting the tempered-glass front filter, the plasma display device can be reduced in cost and weight. In this embodiment, even when an external force is applied to the front panel 5, the PDP 1 is not deformed. This embodiment does not require to newly add a member to the conventional plasma display device. This can realize the above structure without substantial increase of cost.

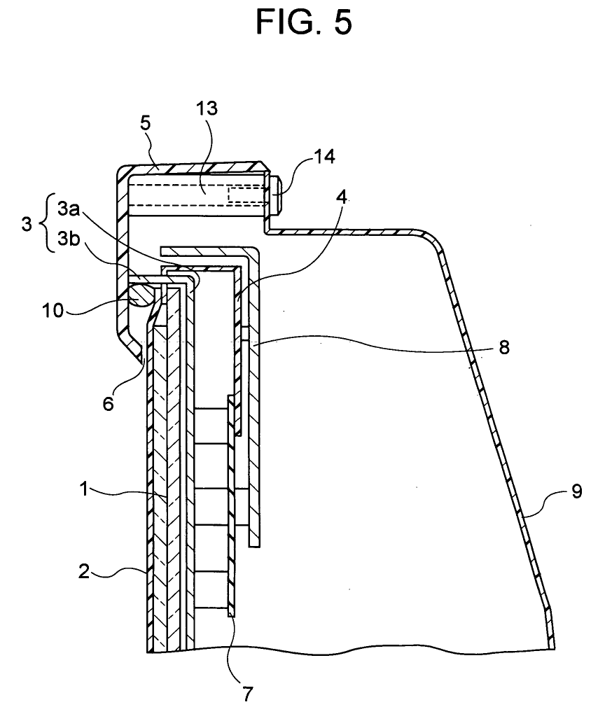

Now explained is a modification to the second embodiment. FIG. 5 is a sectional view showing a plasma display device according to this modification. In this modification, as shown in FIG. 5, the functional film 2 is extended in a manner protruding from an end edge of the PDP 1 front-side substrate similarly to the modification (see FIG. 3) in the first embodiment, and contacted with a connection of the flexible cable 4 with the PDP 1 rear-side substrate. Meanwhile, the functional film 2 has an area at least contacted with the flexible cable 4 where a metal mesh or metal foil is formed on an opposite surface to the surface contacted with the flexible cable 4. A gasket 10 is bonded to the extended portion 3b of the module plate 3. The gasket 10 is placed in contact with the metal mesh or foil of the functional film 2. The gasket 10 has an electric conductivity and elasticity. Due to this, the gasket 10 is adhered to the functional film 2 and to the module plate 3, thus connecting the functional film 2 with the module plate 3. The other of structure than the above in this modification is similar to the second embodiment.

In this modification, by connecting the functional film 2 with the module plate 3 through the gasket 10, the functional film 2 can be grounded without providing a film ground metal. This can reduce the cost for the plasma display device because of no need of a film ground metal. The other operation and effect of the modification than the above is similar to the second embodiment.

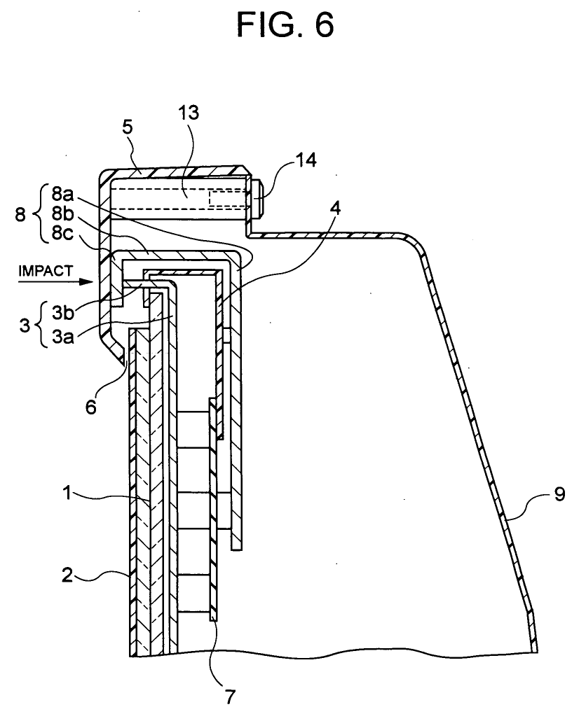

Now explained is a third embodiment of the invention. FIG. 6 is a sectional view showing a plasma display device according to this embodiment. This embodiment is a combination of the first embodiment and the second embodiment, as shown in FIG. 6. Namely, in the plasma display device of this embodiment, the heat sink 8 is made in a squared-U form similarly to the first embodiment wherein the portion 8c is in abutment against the backside of the front panel 5. Meanwhile, similarly to the second embodiment, the module plate 3 is provided with an extended portion 3b extending frontward. The extended portion 3b has a tip abutting against a portion 8c of the heat sink 8. The extended portion 3b of the module plate 3 is made in such a form as not to interfere with the flexible cable 4, e.g. comb form. In this embodiment, the module plate 3 and the heat sink 3 structures a support member fixed on the PDP 1 and abutting against the backside of the front panel 5 thereby supporting the PDP 1 in a position spaced by a gap 6 from the front panel 5. The other of structure in this modification is similar to the first embodiment.

Now explained is the operation of this embodiment structured as above. In the plasma display device of this embodiment, the heat sink 8 abuts against the inner surface of the front panel 5 wherein, furthermore, the module plate 3 abuts against the heat sink 8. In the event an external force such as an impact is applied to the front panel 5, the heat sink 8 and the module plate 3 reinforce the front panel 5 thus suppressing the front panel 5 from deforming. Meanwhile, should a strong force be applied to deform the front panel 5, deforming the front panel 5 causes the heat sink 8, module plate 3 and PDP 1 to deflect rearward. Because this moves the PDP 1 rearward, the gap 6 is maintained between the front panel 5 and the functional film 2. Meanwhile, in case the front panel 5 is contacted with the PDP 1, the force of the front panel 5 pushing the PDP 1 is weakened to prevent the PDP 1 from deforming. As a result, the PDP 1 is not directly applied by a force and hence the PDP 1 is not deformed. The other effect than the above in this embodiment is similar to the first and second embodiments.

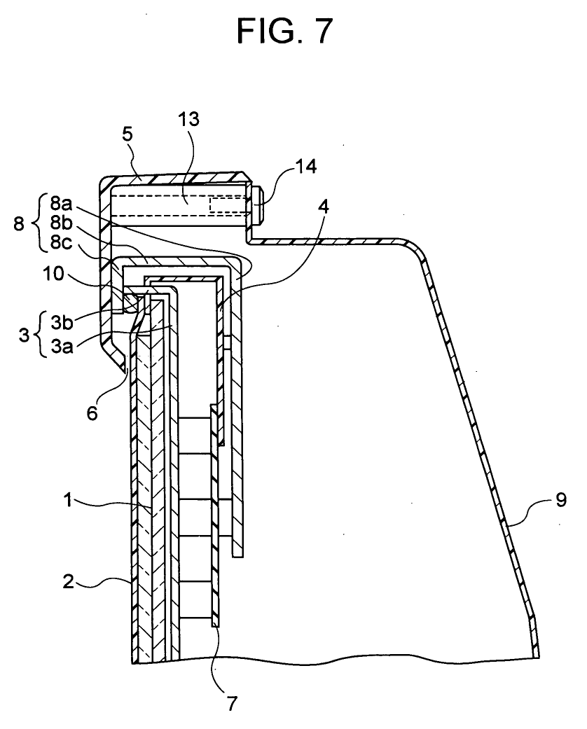

Now explained is a modification to the third embodiment. FIG. 7 is a sectional view showing a plasma display device according to this modification. In this modification, the functional film 2 is extended protruding from an end edge of the PDP 1 front-side substrate and contacted with a connection of the flexible cable 4 with the PDP 1 back-side substrate similarly to the modification of the first embodiment (see FIG. 3), as shown in FIG. 7. Meanwhile, the functional film 2 has an area at least contacted with the flexible cable 4 where a metal mesh or metal foil is formed on an opposite surface to the surface contacted with the flexible cable 4. A gasket 10 is bonded to the extended portion 3b of the module plate 3 or portion 8c of the heat sink 8. The gasket 10 is arranged in a space surrounded in three directions by a contact of the functional film 2 with the flexible cable 4, an extended portion 3b of the module plate 3 and a portion 8c of the heat sink 8. The gasket 10 is in contact with a metal mesh or foil of the functional film 2. Due to this, the gasket 10 is adhered to the functional film 2, module plate 3 and heat sink 3, thus connecting the functional film 2 with the module plate 3. The other of structure than the above in this modification is similar to the third embodiment.

In this modification, the functional film 2 can be grounded to the module plate 3 through the gasket 10. This eliminates the necessity of a film ground metal, thus reducing the cost for the plasma display device. The other operation and effect of the modification than the above is similar to the third embodiment.

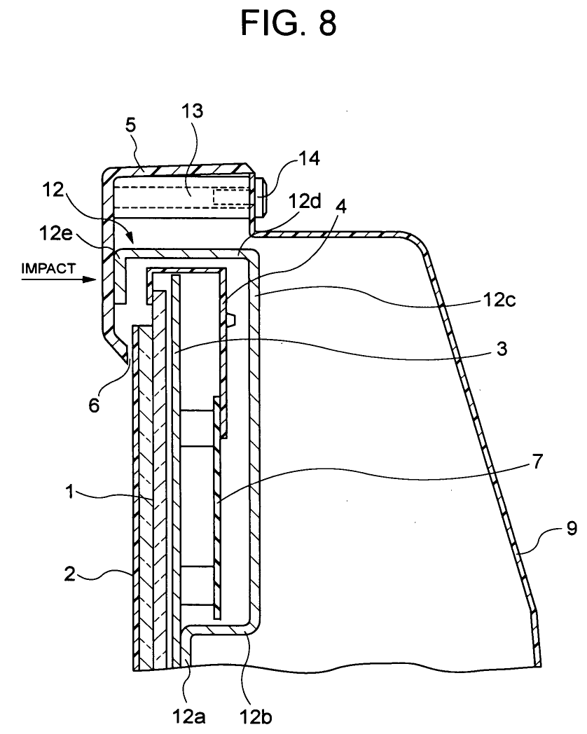

Now explained a fourth embodiment of the invention. FIG. 8 is a sectional view showing a plasma display device according to this embodiment. The plasma display device in this embodiment is provided with a reinforcement metal 12. The reinforcement metal 12 is formed with five portions 12a to 12e joined in this order. Note that the reinforcement metal 12 may be formed with 12a to 12e made by independent plate members that are joined together, or may be formed by one plate bent rectangular four times. Incidentally, the material and size structuring the reinforcement metal 12 is not especially limited but is required to provide a certain degree of rigidity to the reinforcement metal 12.

The portion 12a of the reinforcement metal 12 is provided parallel with the module plate 3 and firmly joined to the module plate 3. Meanwhile, the portion 12b extends rearwards from an end edge of the portion 12a to a rear of the PDP drive board 7 through passing laterally of the PDP drive board 7. Furthermore, the portion 12c extends parallel with the module plate 3 from an end edge of the portion 12b thus being arranged rear of the module plate 3 and PDP drive board 7. Furthermore, the portion 12d extends frontward from an end edge of the portion 12c reaches an abutment position against the backside (inner surface) of the front panel 5 through passing laterally of the PDP drive board 7, module plate 3 and PDP 1. The portion 12e extends in a direction parallel with a surface of the PDP 1 while contacting with the front panel 5 from a frontward end edge of the portion 12d.

Due to this, the reinforcement metal 12 is fixed to the PDP 1 by being joined at its one end (portion 12a) with the module plate 3, the other end (portion 12e) of which abuts against the front panel 5 by passing rearward of the PDP drive board 7 and laterally of the PDP drive board 7, module plate 3 and PDP 1. Incidentally, this embodiment is not provided with a heat sink 8. Due to this, the module plate 3 and the reinforcement metal 12 structures a support member fixed to the PDP 1 and abutted against the backside of the front panel 5 thereby supporting the PDP 1 in a position spaced through a gap 6 from the front panel 5. In this embodiment, the other structure than the above in this embodiment is similar to the first embodiment.

Now explained is the operation of this embodiment structured as above. In the plasma display device of this embodiment, the portion 12e of the reinforcement metal 12 abutment against the inner surface of the front panel 5. In the event an external force such as an impact is applied to the front panel 5, the reinforcement metal 12 acts as a support to the front panel 5, thus suppressing the front panel 5 from deforming. Meanwhile, should a strong external force be applied to deform the front panel 5 to deform the front panel 5, the front panel 5 is deformed to deflect rearward the entire structure made up by the module plate 3 and PDP 1. Thus, the PDP 1 is moved rearward to maintain the gap 6 between the front panel 5 and the functional film 2. Meanwhile, even in case the front panel 5 contacts the PDP 1, the force of the front panel 5 pushing the PDP 1 is weakened to less deform the PDP 1. As a result, the PDP 1 is not directly applied by a force and hence the PDP 1 is not deformed. The effect in this embodiment is similar to the first embodiment.

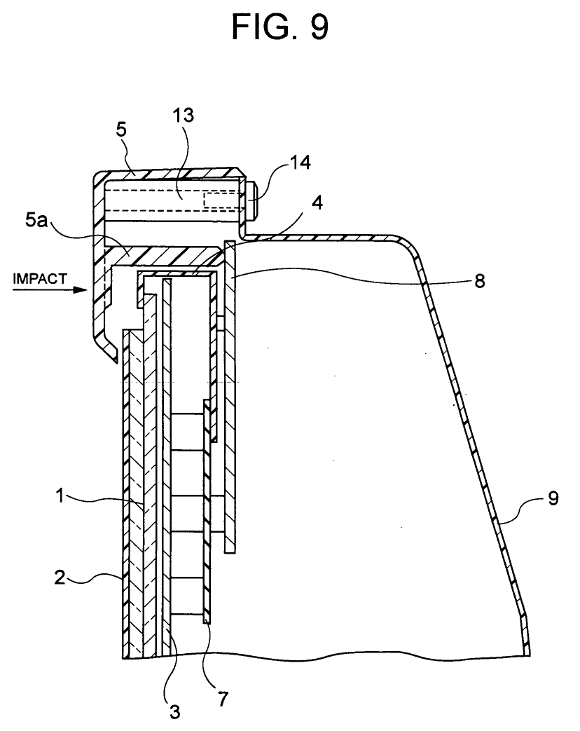

Now explained is a fifth embodiment of the invention. FIG. 9 is a sectional view showing a plasma display device according to the present embodiment. In the plasma display device of this embodiment, the heat sink 8 is not bent but in a plate form, as shown in FIG. 9. Meanwhile, the front panel 5 is formed with a rib (hub) 5a provided standing rearward from an inner surface of the front panel 5. The rib 5a has a rear tip abutting against the heat sink 8. In this embodiment, the other structure than the above is similar to the first embodiment.

In the plasma display device of this embodiment, when an external force is applied to the front panel 5, the rib 5a and the heat sink 8 act as a support to the front panel 5 thus suppressing the front panel 5 from deforming. Meanwhile, should a strong external force be applied to thereby deform the front panel 5, deforming the front panel 5 urges rearward the abutment of the heat sink 8 against the rib 5a thereby deflecting rearward the entire structure made up by the module plate 3 and PDP 1. Thus, the PDP 1 is moved rearward to maintain the gap 6 between the front panel 5 and the functional film 2. As a result, the PDP 1 is not directly applied by a force and hence the PDP 1 is not deformed. Meanwhile, in case the front panel 5 contacts the PDP 1, the force of the front panel 5 pushing the PDP 1 is weakened thus preventing against the PDP 1 from deforming. The other effect than the above in this embodiment is similar to the first embodiment.

Incidentally, this embodiment showed the example the rib 5a is in abutment against the heat sink 8. However, the invention is not limited to the same but the rib 5a may be in abutment against the module plate 3 or against both of the heat sink 8 and the module plate 3.

Meanwhile, the embodiments showed the examples the functional film 2 is given a function to shield against unwanted radiation. However, the invention is not limited to the same but other functions may be provided, e.g. a function preventing against external light reflection or a function protecting the PDP front-side substrate. Two or more functions may be provided in combination.

Furthermore, in the embodiments, the member abutting against the backside of the front panel 5, e.g. heat sink 8, module plate 3 or reinforcement metal 12, may be joined with the front panel 5.

Furthermore, in the embodiments, in place of providing the gasket 10 connected to the functional film 2, a member abutting against the front panel 5, e.g. heat sink 8, module plate 3 or reinforcement metal 12, may be extended to a position contacting with an extension of the functional film 2. This eliminates the necessity of separately providing a connection member, which can reduce the cost for the plasma display device furthermore.

Furthermore, the embodiments explained the example providing a gap 6 between the end edge of front panel 5 close to the aperture and the functional film 2 of the PDP 1. However, the invention is not limited to it, e.g. the front panel 5 may be in contact with the functional film 2. In this case, when an external force is applied to the front panel 5, the PDP 1 deflects rearwards, thus relaxing the force of the front panel 5 pushing the PDP 1. Due to this, the PDP 1 can be prevented from being deformed due to strong pushing the PDP 1 by the front panel 5.

Furthermore, although the embodiments explained the plasma display devices, the invention is not limited to those but can be applied to other display devices than plasma displays. In this case, the functional film may not be provided for a display device less in unwanted radiation of an electromagnetic wave from the display panel, e.g. a liquid-crystal display device. In this case, a constant gap may be provided between the display-panel front-side substrate and the front panel. Otherwise, the display-panel front-side substrate may be in contact with the front panel.

The present invention is usable for a display device having a display panel and a frame-formed front panel covering the peripheral region of the display panel, and suited for use particularly on a display device forming a front panel of a resin without providing a front filter of a tempered glass in order to reduce the cost and weight thereof.

This application is based on Japanese Patent Application No. 2004-166909 which is hereby incorporated by reference.

What is claimed is:

1. A display device comprising:
a display panel;
a front panel covering at least one part of a region other than a display region of the display panel; and
a drive component connected to the display panel and for driving the display panel;
the drive component being fixed on the display panel, wherein at least one of constituent members configuring the drive component is in abutment against the front panel.

2. A display device according to claim 1, wherein the display panel is supported in a position spaced from the front panel.

3. A display device comprising:
a display panel;
a front panel covering a peripheral region in a front surface of the display panel and exposing a display region thereof; and
a drive component connected to the display panel and for driving the display panel;
the drive component being fixed on the display panel, wherein at least one of constituent members configuring the drive component is in abutment against the front panel.

4. A display panel according to any of claims 1 to 3, wherein the drive component has a drive circuit device for driving the display panel and a heat sink for releasing a heat generated from the drive circuit device, the heat sink being fixed on the display panel and abutted against a backside of the front panel.

5. A display device according to claim 4, wherein the heat sink has a first portion arranged rear of the display panel and fixed on the display panel and a second portion extending frontward from an end of the first portion and passing laterally of the display panel into an abutment against the front panel.

6. A display device according to claim 4, wherein the front panel has a rib provided standing rearward, the rib being abutted against the heat sink.

7. A display device according to any of claims 1 to 3, wherein the drive component has a drive circuit device for driving the display panel and a module plate supporting the drive circuit device, the module plate being fixed on the display panel and abutted against a backside of the front panel.

8. A display device according to claim 7, wherein the module plate has a main body portion arranged rear of the display panel and fixed on the display panel to thereby support the drive circuit device, and an extended portion extending frontward from an end of the main body portion and passing laterally of the display panel into abutment against the front panel.

9. A display device according to claim 8, wherein the drive component has a flexible cable connecting the drive circuit device to the display panel, the extended portion of the module plate being made in a comb form having a plurality of teeth arranged parallel one with another, the flexible cable being inserted through between the teeth of the extended portion.

10. A display device according to claim 7, wherein the front panel has a rib provided standing rearward, the rib being abutted against the module plate.

11. A display device according to any one of claims 1 to 3, wherein the drive component has a drive circuit device for driving the display panel, a module plate fixed on the display panel and supporting the drive circuit device, and a reinforcing member joined to the module plate and abutted against a backside of the front panel.

12. A display device according to any one of claims 1 to 11, wherein the display panel has a film put on a front-side substrate of the display panel and shielding an electromagnetic wave radiated from the display panel.

13. A display device according to claim 12, including a connection member for electrically connecting the film with the drive component.

14. A display device according to claim 13, wherein the connection member is a gasket having an electric conductivity and an elasticity.

15. A display device according to any one of claims 1 to 14, wherein the display panel is a plasma display panel.

16. A plasma display device comprising:
a plasma display panel;
a front panel covering a peripheral region in a front surface of the plasma display panel and exposing a display region thereof;
a drive circuit device for driving the plasma display panel; and
a heat sink fixed on the plasma display panel and abutted against a backside of the front panel, to thereby release a heat generated from the drive circuit device.

17. A plasma display device according to claim 16, wherein the plasma display panel has a front-side substrate put thereon with a film for shielding an electromagnetic wave radiated from the plasma display panel, an electric conductor member being provided to connect the film to the heat sink.

18. A plasma display device comprising:
a plasma display panel;
a front panel covering a peripheral region in a front surface of the plasma display panel and exposing a display region thereof;
a drive circuit device for driving the plasma display panel; and
a module plate fixed on the plasma display panel and abutted against a backside of the front panel, thus supporting the drive circuit device.

19. A plasma display device according to claim 18, wherein the plasma display panel has a front-side substrate put thereon with a film for shielding an electromagnetic wave radiated from the plasma display panel, an electric conductor member being provided to connect the film to the module plate.

20. A plasma display device comprising:
a plasma display panel;
a front panel covering a peripheral region in a front surface of the plasma display panel and exposing a display region thereof;
a drive circuit device for driving the plasma display panel;
a module plate fixed on the plasma display panel and supporting the drive circuit device; and
a heat sink fixed on the plasma display panel and abutted against a backside of the front panel, to thereby release a heat generated from the drive circuit device;
the module plate having an end abutting against an abutment portion of the heat sink against the front panel.

21. A plasma display device according to claim 20, wherein the plasma display panel has a front-side substrate put thereon with a film for shielding an electromagnetic wave radiated from the plasma display panel, an electric conductor member being provided to connect the film to at least one of the module plate and the heat sink.

22. A plasma display device comprising:
a plasma display panel;
a front panel covering a peripheral region in a front surface of the plasma display panel and exposing a display region thereof; and
a reinforcement member fixed on the plasma display panel and abutting against a backside of the front panel.

23. A plasma display device comprising:
a plasma display panel;
a front panel covering a peripheral region in a front surface of the plasma display panel and exposing a display region thereof;
a drive circuit device for driving the plasma display panel; and
a heat sink fixed on the plasma display panel and for releasing a heat generated from the drive circuit device;
the front panel being formed with a rib provided standing rearward, the rib having a tip abutting against the heat sink.
